(19) United States
(12) Patent Application Publication
(10) Pub. No.: US 2015/0112010 A1
(43) Pub. Date: Apr. 23, 2015

(54) SEALANT COMPOSITIONS WITH A POLYURETHANE DISPERSION AND A HYDROXY-FUNCTIONAL COMPOUND

(71) Applicant: Bayer MaterialScience LLC, Pittsburgh, PA (US)

(72) Inventors: Jay Johnston, Clinton, PA (US); Chelsey Sear, Baden, PA (US); Ayla Pasquini, Pittsburgh, PA (US)

(73) Assignee: Bayer MaterialScience LLC, Pittsburgh, PA (US)

(21) Appl. No.: 14/057,330

(22) Filed: Oct. 18, 2013

(51) Int. Cl. C09J 175/08

(52) U.S. Cl. CPC C09J 175/08
USPC 524/425; 525/460; 524/590

(57) ABSTRACT

Disclosed are compositions that include (a) an aqueous polyurethane dispersion prepared from an isocyanate-terminated prepolymer; and (b) a hydroxyl-functional compound having an average hydroxyl equivalent weight of greater than 40 gram/equivalent to less than 500 gram/equivalent. Also disclosed are methods of using the compositions as, for example, a sealant.

### FIELD OF THE INVENTION

The present invention relates to compositions and methods for using such compositions as, for example, a sealant.

### BACKGROUND

Sealants are widely used in building materials as waterproofing agents, environmental barriers, and to accommodate changes in the size of materials due to thermal, moisture and structural movements, including vibration and creep.

Sealants based on aqueous polyurethane dispersions (“PUD”) are desirable in many applications, because, among other things, they can be conveniently embodied as a single-component composition and can have a low content of volatile organic compounds. High performance sealants, however, should exhibit a combination of several properties, including low (no more than 100 psi) modulus at 100% extension, high (>300%) elongation, moderate (50 to 200 psi) tensile strength, and high (around 30 pli) tear resistance. Historically, to achieve low modulus with sealants based on polyurethane dispersions, non-functional plasticizers, such as phthalic acid esters, adipic acid esters, alkylsulphonic acid esters of phenol, or phosphoric acid esters, have been added in relatively high levels. Sealants with high levels of such plasticizers, however, are more likely to experience a “leaching out” of the plasticizer from the sealant over time or on heat aging, which is a phenomenon sometimes referred to as syneresis. This loss of plasticizer can cause a change in the physical properties of the sealant, loss of adhesion of the sealant to the substrate, and/or reduced paintability of the sealant.

Thus, it would be desirable to provide PUD-based sealants that do not require a large amount of plasticizer, particularly a non-functional plasticizer, to achieve a sealant with a good combination of physical properties, such as low modulus at 100% extension, moderate tensile strength, high elongation, and high tear resistance.

### SUMMARY OF THE INVENTION

In some respects, the present invention is directed to compositions comprising: (a) an aqueous polyurethane dispersion prepared from an isocyanate-terminated prepolymer comprising a reaction product of components comprising: (i) a polyol component; (ii) a carboxylic acid comprising a hydroxyl and/or an amine group; and (iii) a polyisocyanate; and (b) a hydroxyl-functional compound having an average hydroxyl equivalent weight of greater than 40 gram/equivalent to less than 500 gram/equivalent.

In other respects, the present invention is directed to compositions comprising: (a) an aqueous polyurethane dispersion prepared from an isocyanate-terminated prepolymer having an isocyanate content of 2 to 7 weight percent and comprising a reaction product of components comprising: (i) a polyol component comprising: (A) polyether dial having a molecular weight of 3000 to 6000; and (B) a diol or triol having a molecular weight of up to 700; (ii) a hydroxyalkane carboxylic acid having a molecular weight of less than 200; and (iii) an aliphatic and/or cycloaliphatic diisocyanate; and (b) a hydroxyl-functional compound having an average hydroxyl equivalent weight of greater than 40 gram/equivalent to less than 500 gram/equivalent.

In some respects, the present invention is directed to compositions comprising: (a) 20 to 80 percent by weight, based on the total weight of the composition, of an aqueous polyurethane dispersion prepared from an isocyanate-terminated prepolymer having an isocyanate content of 2 to 7 weight percent and comprising a reaction product of components comprising: (i) a polyol component comprising: (A) polyether diol having a molecular weight of 3000 to 6000; (B) a diol or triol having a molecular weight of up to 700; (ii) a hydroxyalkane carboxylic acid having a molecular weight of less than 200; and (iii) an aliphatic and/or cycloaliphatic diisocyanate; (b) 5 to 25 percent by weight, based on the total weight of the composition, of a hydroxyl-functional compound having an average hydroxyl equivalent weight of greater than 40 gram/equivalent to less than 500 gram/equivalent; and (c) 30 to 50 percent by weight of a filler, based on the total weight of the composition.

The present invention also relates to, among other things, methods for using such compositions and apertures at least partially sealed with a sealant deposited from such compositions.

### DETAILED DESCRIPTION OF THE INVENTION

Various embodiments are described and illustrated in this specification to provide an overall understanding of the structure, function, operation, manufacture, and use of the disclosed products and processes. It is understood that the various embodiments described and illustrated in this specification are non-limiting and non-exhaustive. Thus, the invention is not limited by the description of the various non-limiting and non-exhaustive embodiments disclosed in this specification. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. Therefore, any such amendments comply with the requirements of 35 U.S.C. §112 and 35 U.S.C. §132(a). The various embodiments disclosed and described in this specification can comprise, consist of, or consist essentially of the features and characteristics as variously described herein.

Any patent, publication, or other disclosure material identified herein is incorporated herein by reference in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “certain embodiments”, “some embodiments”, “various non-limiting embodiments,” or the like, means that a particular feature or characteristic may be included in an embodiment. Thus, use of such phrases, and similar phrases, in this specification does not necessarily refer to a common embodiment, and may refer to different embodiments. Further, the particular features or characteristics may be combined in any suitable manner in one or more embodiments. Thus, the particular features or characteristics illustrated or described in connection with various embodiments may be combined, in whole or in part, with the features or characteristics of one or more other embodiments without limitation. Such modifications and variations are intended to be included within the scope of the present specification. In this manner, the various embodiments described in this specification are non-limiting and non-exhaustive.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges subsumed within the recited range. For example, a range of “1 to 10” is intended to include all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. §112 and 35 U.S.C. §132(a).

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

As used herein, the term “polymer” encompasses prepolymers, oligomers and both homopolymers and copolymers; the prefix “poly” in this context referring to two or more. As used herein, the term “molecular weight, when used with reference to a hydroxyl-functional polymer, refers to a calculated molecular weight, which is determined by measuring the hydroxyl number of the polymer by ASTM D2849-69 Part 26 (1975) and then calculating the molecular weight by the formula: Molecular weight=(56100×functionality)/hydroxyl number.

As indicated, certain embodiments of the present invention are directed to compositions comprising: (a) an aqueous polyurethane dispersion prepared from an isocyanate-terminated prepolymer comprising a reaction product of components comprising: (i) a polyol component; (ii) a carboxylic acid comprising a hydroxyl and/or an amine group; and (iii) a polyisocyanate. In certain embodiments, the isocyanate-terminated prepolymer has an isocyanate group content of 2 to 7 percent by weight.

Suitable polyol components for use in preparing the isocyanate-terminated prepolymer include, for example, at least difunctional polyester polyols, polyether polyols, and polycarbonate polyols.

In certain embodiments of the present invention, the polyol component used to prepare the isocyanate-terminated prepolymer comprises (A) a polyether dial. Suitable polyether diols include, for example, polyaddition products of ethylene oxide, propylene oxide, tetrahydrofuran, butylene oxide and epichlorohydrin, co-addition and graft products thereof, as well as polyether diols obtained by condensation of dihydric alcohols or mixtures thereof and polyether diols obtained by alkoxylation of dihydric alcohols, amines and aminoalcohols.

Examples of suitable dihydric alcohols include diols having a molecular weight of 62 to 2000 which optionally contain ether groups, ester groups and/or carbonate groups. Specific examples of suitable dihydric alcohols include ethylene glycol, 1,2- and 1,3-propanediol, 1,3-, 2,3- and 1,4-butanediol, 1,6-hexanediol, diethylene glycol, dipropylene glycol, neopentyl glycol and mixtures of these diols. Other suitable diols include ethanediol, 1,5-pentanediol, 2,2-dimethyl-1,3-propanediol, 1,4-dihydroxycyclohexane, 1,4-dimethylolcyclohexane, 1,8-octanediol, 1,10-decanediol, 1,12-dodecanediol, triethylene glycol, tetraethylene glycol, tripropylene glycol, tetrapropylene glycol, polycarbonate diols having hydroxyl numbers of 56 to 168 (which may be obtained by reacting any of the preceding diols with diphenyl carbonate, dimethyl carbonate, diethylene glycol carbonate or phosgene), and dimeric fatty alcohols. Cycloaliphatic dihydroxyl compounds are also suitable as the dihydric alcohol(s). Mixtures of any of the preceding diols can also be used.

As used herein, the term “dimeric fatty alcohol” means diols which can be obtained from technical dimerized fatty acids. Dimerized fatty acids are those containing at least 75% by weight of dimeric acids, i.e., dicarboxylic acids having an average of 30 to 45 carbon atoms per molecule. The conversion of the dimeric fatty acids into dimeric fatty alcohols can be carried out, for example, by reduction of the carboxyl groups to hydroxyl groups, esterification of the carboxyl groups with the previously described low molecular weight diols or by alkoxylation of the carboxyl groups, for example, by means of ethylene oxide and/or propylene oxide. An example of a dimeric fatty alcohol suitable for use in preparing the polyether diol is Pripol™ 2033 from Unichema.

In some embodiments of the present invention, the polyether diol used to prepare the isocyanate-terminated prepolymer comprises a polyoxypropylene diol having a molecular weight of 3000 to 6000, such as 3000 to 5000, and having an unsaturated terminal group content of less than or equal to 0.02 milliequivalents, such as from 0.005 to 0.015 milliequivalents (method used for determination ASTM D2849-69) per gram polyol, which are obtained by known methods by double metal cyanide complex-catalyzed (DMC-catalyzed) polymerization of alkylene oxides, such as propylene oxides, such as is described, for example, in U.S. Pat. No. 5,158,922 (e.g., Example 30) or European Patent 654,302 (p. 5, line 26 to p. 6, line 32). A specific example of a polyether diol suitable for use in preparing the isocyanate-terminated prepolymer is Acclaim® 4200 N (a 4000 molecular weight polyoxypropylene diol), available from Bayer AG, Leverkusen, Germany.

In certain embodiments of the present invention, the polyol component used to prepare the isocyanate-terminated prepolymer comprises, in addition to or in lieu of the foregoing polyether diol, (B) a diol or triol having a molecular weight of up to 700, such as 200 to 700.

Examples of diols and triols having a molecular weight of up to 700, such as 200 to 700, which are suitable for use in preparing the isocyanate-terminated prepolymer, include, for example, polyether polyols (prepared as described above), including polyoxypropylene diols, and polyester polyols prepared, for example, from alcohols and dicarboxylic acids, wherein the polyether polyol and/or polyester polyol has a molecular weight within the aforementioned range. Examples of suitable alcohols include those listed above for preparation of polyether diols. Examples of suitable dicarboxylic acids are aromatic dicarboxylic acids such as phthalic acid, isophthalic acid and terephthalic acid, cycloaliphatic dicarboxylic acids such as hexahydrophthalic acid, tetrahydrophthalic acid, endomethylene-tetrahydrophthalic acid and their anhydrides and aliphatic dicarboxylic acids, such as succinic acid, glutaric acid, adipic acid, phthalic acid, isophthalic acid, tetrahydrophthalic acid, suberic acid, azelaic acid and sebacic acid or their anhydrides.

The polyester polyols may also be homopolymers or copolymers of lactones, which are preferably obtained by addition reactions of lactones or lactone mixtures, such as butyrolactone, ε-caprolactone and/or methyl-ε-caprolactone with the suitable difunctional and/or higher-functional starter molecules such as, for example, the low molecular weight polyhydric alcohols mentioned above as structural components for polyester polyols.

In some embodiments of the present invention, the polyol component used to prepare the isocyanate-functional prepolymer comprises a polyester polyol, such as a polycaprolactone dial of molecular weight range from 200 to 700 which have been prepared from a diol or diol mixture of the type exemplified above, as starter, and ε-caprolactone. Suitable starter molecules are dimethylol butanoic acid (DMBA) and dimethyl propionic acid (DMPA).

In some embodiments, a diol or trial having a molecular weight of up to 700, such as 200 to 700, which is suitable for use in preparing the isocyanate-terminated prepolymer, is a fatty acid ester having a hydroxyl group, such as castor oil.

If desired, the polyol component used to prepare the isocyanate-functional prepolymer may, in addition to or in lieu of the foregoing polyether diol (A) and/or dial or trial having a molecular weight of up to 700 (B), also include (C) a triol, such as a polyether triol, having a molecular weight of 3,000 to 9,000.

Polyether trials having a molecular weight of 3,000 to 9,000, such as 5,000 to 7,000, that are suitable for use in preparing the isocyanate-functional prepolymer can be as described above for polyether diols, using suitable trihydric alcohols. Suitable triyhric alcohols include, for example, trimethylolethane, trimethylolpropane and glycerol and mixtures thereof.

In the present invention, the isocyanate-terminated prepolymer comprises a reaction product of components comprising a carboxylic acid comprising a hydroxyl and/or an amine group, examples of which include hydroxyalkane carboxylic acids having a molecular weight of less than 200. Specific examples of hydroxyalkane carboxylic acids suitable for use in preparing the isocyanate-terminated prepolymer include dimethylolacetic acid, dimethylolpropionic acid, dimethylolbutyric acid, dimethylolvaleric acid, citric acid, tartaric acid, and mixtures thereof.

In certain embodiments, the isocyanate-terminated prepolymer comprises a reaction product of components that further comprise a monol, such as a polyether monol having a molecular weight of 400 to 3000, such as 1500 to 2500.

Suitable polyether monols can be prepared, for example, as described above for polyether diols, using one or more suitable monofunctional alcohol, such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols, hydroxymethyl-cyclohexane, 3-ethyl-3-hydroxymethyloxetane or tetrahydrofurfuryl alcohol; diethylene glycol monoalkyl ethers such as diethylene glycol monobutyl ether; unsaturated alcohols such as allyl alcohol, 1,1-dimethylallyl alcohol or oleyl alcohol; aromatic alcohols (phenols) such as phenol, the isomeric cresols or methoxyphenols; and araliphatic alcohols such as benzyl alcohol, anisyl alcohol or cinnamyl alcohol.

In the present invention, the isocyanate-terminated prepolymer comprises a reaction product of components comprising a polyisocyanate. Suitable polyisocyanates include any linear or branched aliphatic or cycloaliphatic organic compound which have at least two free isocyanate groups per molecule, such as, for example, diisocyanates X(NCO)₂, with X representing a bivalent aliphatic hydrocarbon radical, such as a bivalent aliphatic hydrocarbon radical having from 4 to 12 carbon atoms or a bivalent cycloaliphatic hydrocarbon radical having from 6 to 15 carbon atoms. Further examples of compounds which are usable as a diisocyanate component are described, for example, by W. Siefken in Justus Liebig's Annalen der Chemie, 562, pp. 75-136.

Some non-limiting examples of suitable diisocyanates are tetramethylene diisocyanate, methylpentamethylene diisocyanate, 1,6-hexamethylene diisocyanate, dodecamethylene diisocyanate, 1,4-diisocyanatocyclohexane, 1-isocyanato-3,3,5-trimethyl-5-isocyanatomethylcyclohexane, p-isopropylidene diisocyanate, 1-isocyanato-3,3,5-trimethyl-5-isocyanatomethyl cyclohexane, 1,6-hexamethylene diisocyanate, 4,4′-diisocyanatodicyclohexylmethane, 4,4′-, 2,4′- and 2,2′-diisocyanatodiphenylmethane (MDI monomers), toluene diisocyanate (TDI) and tetramethyl xylene diisocyanate (TMXDI). Mixtures of these diisocyanates can also be used.

It is also possible to (co-) use small amounts of the higher-functional polyisocyanates which are known in polyurethane chemistry and modified polyisocyanates having, for example, carbodiimide groups, allophanate groups, isocyanurate groups, urethane groups and/or biuret groups.

In certain embodiments, preparation of the prepolymer takes place within the temperature range 20 to 130° C., such as 50 to 120° C., or 70 to 105° C. In certain embodiments, the components are reacted in relative amounts such that the ratio of isocyanate groups to hydroxyl groups is in the range of 3:1 to 1, 4:1, such as 1.7:1 to 1.4:1.

Optionally, a solvent that is inert towards isocyanate groups can be used in the preparation of the prepolymer. Examples of suitable solvents are, for example, ethyl acetate, butyl acetate, ethylene glycol monomethyl or monoethyl ether acetate, 1-methoxyprop-2-yl acetate, 3-methoxy-n-butyl acetate, acetone, 2-butanone, 4-methyl-2-pentanone, cyclohexanone, toluene, xylene, chlorobenzene, mineral spirits, aromatics with relatively high levels of substitution, such as those under the names Solvent naphtha, Solvesso™, Isopar™, Nappar™ (Deutsche EXXON CHEMICAL GmbH, Cologne, Del.) and Shellsol™ (Deutsche Shell Chemie GmbH, Eschborn, Del.), carbonic esters, such as dimethyl carbonate, diethyl carbonate, 1,2-ethylene carbonate and 1,2-propylene carbonate, lactones, such as ε-propiolactone, γ-butyrolactone, ε-caprolactone and ε-methylcaprolactone, and also solvents such as propylene glycol diacetate, diethylene glycol dimethyl ether, dipropylene glycol dimethyl ether, diethylene glycol ethyl and butyl ether acetate, N-methylpyrrolidone, N-ethylpyrrolidone and N-methylcaprolactam, or any desired mixtures of such solvents.

In certain embodiments, the components used to prepare the isocyanate-functional prepolymer are used in the following amounts: (1) 30 to 80 weight percent, such as 50 to 70 weight percent, polyether diol having a molecular weight of 3000 to 6000; (2) 3 to 15 weight percent, such as 5 to 10 weight percent, diol or triol having a molecular weight of up to 700, such as 200 to 700; (3) 1 to 20 weight percent, such as 1.5 to 10 weight percent carboxylic acid comprising a hydroxyl and/or an amine group; (4) 0 to 40 weight percent, such as 2 to 5 weight percent, polyether monol having a molecular weight of 400 to 3,000; and (5) 0 to 15 weight percent, such as 2 to 10 weight percent, polyether triol having a molecular weight of 3,000 to 9,000, all weight percentages being based on the total weight of the prepolymer.

In certain embodiments, the ratio of the components is such that the isocyanate group content of the resulting prepolymer(s) is between 2 and 7 weight percent, such as 2 to 4 weight percent, the weight percent being based on the weight of the prepolymer.

Prior to dispersion in water, at least a portion of the free carboxylic acid groups in the prepolymer composition are often neutralized with a neutralizing agent. In embodiments, at least 50%, such as 80% to 120%, or, in some cases, 95 to 100%, of the carboxylic acid groups present in the polyurethane of the invention are neutralized with suitable neutralizing agents.

Examples of suitable neutralizing agents include triethylamine, dimethylamino-ethanol, dimethylcyclohexylamine, triethanolamine, methyldiethanolamine, diisopropanolamine, diisopropylcyclohexylamine, N-methylmorpholine, 2-amino-2-methyl-1-propanol, ammonia or other customary neutralizing agents or neutralization mixtures thereof.

The isocyanate-functional prepolymer is then converted into an aqueous dispersion.

The neutralized prepolymer is dispersed in water, optionally in the presence of a surfactant or emulsifier. Suitable surfactants and emulsifiers are well-known in the art. Up to, for example, 10% by weight surfactant can be used, based on the amount of water added. Also optionally, additional solvent can be added to the prepolymer prior to dispersion in water.

The prepolymer composition can optionally be chain-lengthened after dispersion in water to obtain the high molecular weight polyurethane resin. If the acetone process is used, chain extension can be carried out prior to dispersion.

Suitable chain extenders include, for example, aliphatic and/or alicyclic primary and/or secondary diamines including 1,2-ethanediamine, 1,6-hexamethylenediamine, 1-amino-3,3,5-trimethyl-5-aminomethyl cyclohexane(isophorone diamine), piperazine, 1,4-diaminocyclohexane, bis(4-aminocyclohexyl)methane, adipic acid dihydrazide or hydrazine hydrate. Polyether diamines, which may be prepared by reaction of the corresponding polyether diols with ammonia and/or primary amines, are also useful, as are higher-functional amines such as tri- or tetrafunctional amines. In embodiments, the chain extender comprises a diamine, such as 2-methyl-1,5-diaminopentane (Dytek™ A, sold by Dupont). Mixtures of any of the preceding chain extenders can also be used.

The organic solvent may optionally be distilled off in whole or in part at reduced pressure. The quantity of water is such that the resultant aqueous dispersions comprise from 30 to 60 weight percent, such as 35 to 50 weight percent, solids.

In embodiments, the aqueous polyurethane dispersion used in the compositions of the invention may have an average particle diameter (measured by laser correlation spectroscopy) of from 50 to 900 nanometers, such as 60 to 150 nanometers, and may be stable in storage for at least 6 months. In embodiments, the high molecular weight polyurethane resin present in the aqueous polyurethane dispersion has a number average molecular weight of 25,000 to 100,000.

One exemplary aqueous polyurethane dispersion of the type described herein, which is suitable for use in the compositions of the present invention, is Dispercoll® U XP 2699, from Bayer MaterialScience LLC. Suitable aqueous polyurethane dispersions for use in the compositions of the present invention are also described in United States Patent Application Publication No. 2009/0030146 A1 at [0006]-[0061] and [0068]-[0122], the cited portions of which being incorporated herein by reference.

In certain embodiments, the aqueous polyurethane dispersion described above is present in the composition of the present invention in an amount of at least 15 percent by weight, such as at least 20 percent by weight, and/or up to 80 percent by weight, such as up to 60 percent by weight or up to 40 percent by weight, based on the total weight of the composition.

In addition to the aqueous polyurethane dispersion described above, the compositions of the present invention also comprise a hydroxyl-functional compound having an average hydroxyl equivalent weight of greater than 40 gram/equivalent, such as greater than 60 gram/equivalent, or, in some cases, greater than 80 gram/equivalent and less than 500 gram/equivalent, such as less than 400 gram/equivalent, less than 300 gram/equivalent, or, in some cases, less than 250 gram/equivalent, such as 96 gram/equivalent to 212 gram/equivalent. As used herein, the term “average” when used with reference to the hydroxyl equivalent weight of the hydroxyl-functional compound, refers to the weighted average hydroxyl equivalent weight of all hydroxyl-functional compounds present in the composition. Thus, by way of illustration, if the composition includes two hydroxyl-functional compounds, wherein the first hydroxyl-functional compound has a hydroxyl-equivalent weight of 300 grams/equivalent and is present in an amount of 40 percent by weight, based on the total weight of hydroxyl-functional compounds in the composition, and the second hydroxyl-functional compound has a hydroxyl-equivalent weight of 100 grams/equivalent and is present in an amount of 60 percent by weight, based on the total weight of hydroxyl-functional compounds in the composition, then the composition would comprise a hydroxyl-functional compound having an average hydroxyl equivalent weight of 100/(40/300)+(60/100))=136 gram/equivalent. As used herein, the term “hydroxyl equivalent weight”, refers to the quotient of the weight of a molecule (molecular weight) divided by the number of hydroxyl groups in the molecule wherein, in the case of a polymer, the molecular weight is the calculated molecular weight (calculated as described earlier).

Suitable hydroxyl-functional compounds for inclusion in the compositions of the present invention include monols and polyols, including diols and triols, and can be monomers or polymers.

In certain embodiments, the hydroxyl-functional compound comprises a monomeric polyol, such as a diol, having a hydroxyl equivalent weight of greater than 40 gram/equivalent, such as greater than 60 gram/equivalent, or, in some cases, greater than 80 gram/equivalent and less than 500 gram/equivalent, such as less than 400 gram/equivalent, less than 300 gram/equivalent, or, in some cases, less than 250 gram/equivalent. Specific, but non-limiting, examples of suitable monomeric polyols include alkylene glycols, such as 1,3-butanediol (hydroxyl equivalent weight of 45); 2-methyl-1,3-propanediol (hydroxyl equivalent weight of 45); diethylene glycol (hydroxyl equivalent weight of 53); triethylene glycol (hydroxyl equivalent weight of 75); dipropylene glycol (hydroxyl equivalent weight of 67); tripropylene glycol (hydroxyl equivalent weight of 96). Other suitable hydroxyl-functional compounds include, but are not limited to, monols, such as butanol, pentanol, hexanol, heptanol, octanol, nonyl alcohol, decyl alcohol, and higher alkanols, ethoxylated or propoxylated fatty acids, ethoxylated and propoxylated phenols, ethoxylated and propoxylated nonyl phenols, and ethoxylated and propoxylated synthetic alcohols (such as those available under the name EMULGEN); polyols, such as natural oils, such as castor oil, chemically modified soybean oil, and dimer diols.

In certain embodiments, the hydroxyl-functional compound comprises a polymeric hydroxyl-functional compound, such as a polyol, such as a diol, having a hydroxyl equivalent weight of greater than 40 gram/equivalent, such as greater than 60 gram/equivalent, or, in some cases, greater than 80 gram/equivalent and less than 500 gram/equivalent, such as less than 400 gram/equivalent, less than 300 gram/equivalent, or, in some cases, less than 250 gram/equivalent, specific, but-non-limiting, examples of which include polyether polyols, polyester polyols, and the like. Suitable polyether polyols and polyester polyols can be prepared as described above with respect to the polyols that can be used to prepare the isocyanate-terminated prepolymer polymer. In some cases, the polyether polyol is a polypropylene glycol or a mixture of polypropylene glycol and a small amount (up to 12 weight percent) polyethylene glycol. In some embodiments, the polyether polyol made from both ethylene oxide and propylene oxide.

In certain embodiments, the hydroxyl-functional compound mentioned above is present in the composition of the present invention in an amount of at least 5 percent by weight, such as at least 10 percent by weight, at least 15 percent by weight, or at least 20 percent by weight and/or up to 40 percent by weight, such as up to 30 percent by weight or up to 25 percent by weight, based on the total weight of the composition.

It has been discovered, surprisingly, that use of the hydroxyl-functional compound mentioned above in the compositions of the present invention, in the amounts described above, can in at least some cases, result in production of high performance sealants exhibiting low modulus at 100% extension, high elongation properties, moderate tensile strength, and higher tear resistance. Without being bound by any theory, it is currently believed that the hydroxyl-functional compound acts as a plasticizer in the compositions of the present invention by providing a disruption of hydrogen-bonding between polyurethane resin chains, thereby permitting these chains to slip by one another in the sealant more easily. Moreover, it has been observed that the desirable combination of properties can be achieved by using a lower level of hydroxyl-functional compound relative to that which is normally required to achieve similar properties using a non-functional plasticizer. In addition, it is currently believed that where the average hydroxyl equivalent weight of the hydroxyl-functional compound is less than or equal to 40 gram/equivalent, then the hydrogen bonding disruption is too great, thereby negatively impacting physical properties of the sealant, whereas when the average hydroxyl equivalent weight of the hydroxyl-functional compound is greater than or equal to 500 gram/equivalent, then the compound separates from the composition and the hydrogen-bonding disruption is insufficient provide a low modulus at 100% extension sealant.

The compositions of the present invention may be used, for example, as coatings, adhesives, and/or sealants. As a result, in certain embodiments, the compositions of the present invention may further include non-functional plasticizers, fillers, pigments, driers, additives, light stabilizers, antioxidants, thixotropic agents, catalysts, adhesion promoters and, where appropriate, further auxiliaries and additives in accordance with known methods of producing coatings, adhesives, and/or sealants.

Sealant compositions of the present invention in particular will often contain a significant amount of filler. For example, in some cases, a filler, such as calcium carbonate, is present in the compositions of the present invention in an amount of at least 10 percent by weight, such as at least 20 percent by weight, at least 25 percent by weight, or in some cases, at least 30 percent by weight and/or up to 70 percent by weight, such as up to 60 percent by weight, or, in some cases, up to 50 percent by weight, the weight percents being based on the total weight of the composition.

Examples of other suitable fillers for use in the inventive sealant compositions include carbon black, precipitated hydrated silicas, mineral chalk materials and precipitated chalk materials. Examples of suitable non-functional plasticizers include phthalic acid esters, adipic acid esters, alkylsulphonic acid esters of phenol, or phosphoric acid esters. Examples of thixotropic agents include pyrogenic hydrated silicas, polyamides, products derived from hydrogenated castor oil, and also polyvinyl chloride.

The compositions of the present invention can be used for the coating, joining and sealing of materials made, for example, from metal, ceramic, glass, plastic, wood, concrete and other construction materials. In some embodiments, the compositions of the present invention may be used to seal an aperture (i.e., gap) by depositing the composition over at least a portion of the aperture. Such apertures may be present within a single substrate or between two or more different substrates.

Sealants formed from the compositions of the present invention can, in at least some cases, exhibit a desirable combination of properties. For example, in some embodiments, sealants formed from the compositions of the present invention have (i) a tensile strength of 50 to 200 psi, such as 70 to 150 psi or 100 to 150 psi; (ii) a breaking elongation of >300%, such as greater than 400%, greater than 500%, or greater than 600%; (iii) a modulus at 100% extension of no more than 100%, such as 10 to 80 psi; and (iv) a tear resistance of 30 to 60 pH. In the present invention, tensile strength, breaking elongation, and modulus at 100% extension can be determined according to ASTM D412, Method A and tear resistance can be determined by ASTM D624, Die “C”.

As will be appreciated by the foregoing description, embodiments of the present invention are directed to compositions comprising: (a) an aqueous polyurethane dispersion prepared from an isocyanate-terminated prepolymer comprising a reaction product of components comprising: (i) a polyol component; (ii) a carboxylic acid comprising a hydroxyl and/or an amine group; and (iii) a polyisocyanate; and (b) a hydroxyl-functional compound having an average hydroxyl equivalent weight of greater than 40 gram/equivalent to less than 500 gram/equivalent.

In embodiments, the present invention is directed to a composition of the previous paragraph wherein the isocyanate-terminated prepolymer has an isocyanate group content of 2 to 7 weight percent, such as 2 to 4 weight percent.

In embodiments, the present invention is directed to a composition of any of the previous two paragraphs, wherein the polyol component comprises (A) a polyether diol, such as a polyoxypropylene diol, that has a molecular weight of 3000 to 6000.

In embodiments, the present invention is directed to a composition of any of the previous three paragraphs, wherein the polyol component comprises, in addition to or in lieu of (A), (B) a diol or triol having a molecular weight of up to 700, such as 200 to 700, such as a polyester diol, a polyether diol, such as a polyoxypropylene diol, and/or a fatty acid ester having a hydroxyl group, such as castor oil.

In embodiments, the present invention is directed to a composition of any of the previous four paragraphs, wherein in addition to or in lieu of the foregoing polyether diol (A) and/or diol or triol having a molecular weight of up to 700 (B), the polyol component comprises (C) a triol, such as a polyether triol, having a molecular weight of 3,000 to 9,000, such as 5,000 to 7,000.

In embodiments, the present invention is directed to a composition of any of the previous five paragraphs, wherein the carboxylic acid comprising a hydroxyl and/or an amine group comprises a hydroxyalkane carboxylic acid having a molecular weight of less than 200.

In embodiments, the present invention is directed to a composition of any of the previous six paragraphs, wherein the components further comprise a monol, such as a polyether monol having a molecular weight of 400 to 3000, such as 1500 to 2500.

In embodiments, the present invention is directed to a composition of any of the previous seven paragraphs, wherein the isocyanate-terminated prepolymer is prepared by reacting the components in amounts such that the ratio of isocyanate groups to hydroxyl groups is in the range of 3:1 to 1.4:1, such as 1.7:1 to 1.4:1.

In embodiments, the present invention is directed to a composition of any of the previous eight paragraphs, wherein the components used to prepare the isocyanate-functional prepolymer are used in the following amounts: (1) 30 to 80 weight percent, such as 50 to 70 weight percent, polyether diol having a molecular weight of 3000 to 6000; (2) 3 to 15 weight percent, such as 5 to 10 weight percent, diol or triol having a molecular weight of up to 700, such as 200 to 700; (3) 1 to 20 weight percent, such as 1.5 to 10 weight percent carboxylic acid comprising a hydroxyl and/or an amine group; (4) 0 to 40 weight percent, such as 2 to 5 weight percent, polyether monol having a molecular weight between 400-3,000; and (5) 0 to 15 weight percent, such as 2 to 10 weight percent, polyether triol having a molecular weight of 3,000 to 9,000, all weight percentages being based on the total weight of the prepolymer.

In embodiments, the present invention is directed to a composition of any of the previous nine paragraphs, wherein the aqueous polyurethane dispersion is optionally chain extended and optionally has at least a portion of any carboxylic acid groups neutralized.

In embodiments, the present invention is directed to a composition of any of the previous ten paragraphs, wherein the aqueous polyurethane dispersion is present in an amount of at least 15 percent by weight, such as at least 20 percent by weight, and/or up to 80 percent by weight, such as up to 60 percent by weight or up to 40 percent by weight, based on the total weight of the composition.

In embodiments, the present invention is directed to a composition of any of the previous eleven paragraphs, wherein the hydroxyl-functional compound has an average hydroxyl equivalent weight of greater than 60 gram/equivalent or greater than 80 gram/equivalent and less than 400 gram/equivalent or less than 300 gram/equivalent or less than 250 gram/equivalent.

In embodiments, the present invention is directed to a composition of the previous paragraph, wherein the hydroxyl-functional compound has an average hydroxyl equivalent weight of 96 gram/equivalent to 212 gram/equivalent.

In embodiments, the present invention is directed to a composition of any of the previous thirteen paragraphs, wherein the hydroxyl-functional compound comprises a monomeric polyol, such as an alkylene glycol, such as 1,3-butanediol, 2-methyl-1,3-propanediol, diethylene glycol, triethylene glycol, dipropylene glycol, and/or tripropylene glycol, and/or a polymeric polyol, such as a polyether polyol, such as a polypropylene glycol.

In embodiments, the present invention is directed to a composition of any of the previous fourteen paragraphs, wherein the hydroxyl-functional compound is present in the composition in an amount of at least 5 percent by weight, such as at least 10 percent by weight, at least 15 percent by weight, or at least 20 percent by weight and/or up to 40 percent by weight, such as up to 30 percent by weight or up to 25 percent by weight, based on the total weight of the composition, the weight percents being based on the total weight of the composition.

In embodiments, the present invention is directed to a composition of any of the previous fifteen paragraphs, wherein the composition further comprises a filler, such as calcium carbonate, wherein, in some embodiments, the filler is present in the composition in an amount of at least 10 percent by weight, such as at least 20 percent by weight, at least 25 percent by weight, or in some cases, at least 30 percent by weight and/or up to 70 percent by weight, such as up to 60 percent by weight, or, in some cases, up to 50 percent by weight, the weight percents being based on the total weight of the composition.

In embodiments, the present invention is directed to a method of using a composition of any of the previous sixteen paragraphs, comprising depositing the composition over at least a portion of an aperture to seal the aperture.

As will also be appreciated by the foregoing description, embodiments of the present invention are directed to compositions comprising: (a) an aqueous polyurethane dispersion prepared from an isocyanate-terminated prepolymer having an isocyanate content of 2 to 7 weight percent, such as 2 to 4 weight percent, and comprising a reaction product of components comprising: (i) a polyol component comprising: (A) polyether diol having a molecular weight of 3000 to 6000; and (B) a diol or triol having a molecular weight of up to 700, such as 200 to 700; (ii) a hydroxyalkane carboxylic acid having a molecular weight of less than 200; and (iii) an aliphatic and/or cycloaliphatic diisocyanate; and (b) a hydroxyl-functional compound having an average hydroxyl equivalent weight of greater than 40 gram/equivalent to less than 500 gram/equivalent.

In embodiments, the present invention is directed to a composition of the previous paragraph, wherein the polyether dial comprises a polyoxypropylene diol.

In embodiments, the present invention is directed to a composition of any of the previous two paragraphs, wherein the diol or trial having a molecular weight of up to 700, such as 200 to 700, comprises a polyester dial, a polyether diol, such as a polyoxypropylene diol, and/or a fatty acid ester having a hydroxyl group, such as castor oil.

In embodiments, the present invention is directed to a composition of any of the previous three paragraphs, wherein the polyol component comprises (C) a triol, such as a polyether triol, having a molecular weight of 3,000 to 9,000, such as 5,000 to 7,000.

In embodiments, the present invention is directed to a composition of any of the previous four paragraphs, wherein the components further comprise a monol, such as a polyether monol having a molecular weight of 400 to 3000, such as 1500 to 2500.

In embodiments, the present invention is directed to a composition of any of the previous five paragraphs, wherein the isocyanate-terminated prepolymer is prepared by reacting the components in amounts such that the ratio of isocyanate groups to hydroxyl groups is in the range of 3:1 to 1.4:1, such as 1.7:1 to 1.4:1.

In embodiments, the present invention is directed to a composition of any of the previous six paragraphs, wherein the components used to prepare the isocyanate-functional prepolymer are used in the following amounts: (1) 30 to 80 weight percent, such as 50 to 70 weight percent, polyether dial having a molecular weight of 3000 to 6000; (2) 3 to 15 weight percent, such as 5 to 10 weight percent, dial or triol having a molecular weight of up to 700, such as 200 to 700; (3) 1 to 20 weight percent, such as 1.5 to 10 weight percent carboxylic acid comprising a hydroxyl and/or an amine group; (4) 0 to 40 weight percent, such as 2 to 5 weight percent, polyether monol having a molecular weight between 400-3,000; and (5) 0 to 15 weight percent, such as 2 to 10 weight percent, polyether triol having a molecular weight of 3,000 to 9,000, all weight percentages being based on the total weight of the prepolymer.

In embodiments, the present invention is directed to a composition of any of the previous seven paragraphs, wherein the aqueous polyurethane dispersion is optionally chain extended and optionally has at least a portion of any carboxylic acid groups neutralized.

In embodiments, the present invention is directed to a composition of any of the previous eight paragraphs, wherein the aqueous polyurethane dispersion is present in an amount of at least 15 percent by weight, such as at least 20 percent by weight, and/or up to 80 percent by weight, such as up to 60 percent by weight or up to 40 percent by weight, based on the total weight of the composition.

In embodiments, the present invention is directed to a composition of any of the previous nine paragraphs, wherein the hydroxyl-functional compound has an average hydroxyl equivalent weight of greater than 60 gram/equivalent or greater than 80 gram/equivalent and less than 400 gram/equivalent or less than 300 gram/equivalent or less than 250 gram/equivalent.

In embodiments, the present invention is directed to a composition of the previous paragraph, wherein the hydroxyl-functional compound has an average hydroxyl equivalent weight of 96 gram/equivalent to 212 gram/equivalent.

In embodiments, the present invention is directed to a composition of any of the previous eleven paragraphs, wherein the hydroxyl-functional compound comprises a monomeric polyol, such as an alkylene glycol, such as 1,3-butanediol, 2-methyl-1,3-propanediol, diethylene glycol, triethylene glycol, dipropylene glycol, and/or tripropylene glycol, and/or a polymeric polyol, such as a polyether polyol, such as a polypropylene glycol.

In embodiments, the present invention is directed to a composition of any of the previous twelve paragraphs, wherein the hydroxyl-functional compound is present in the composition in an amount of at least 5 percent by weight, such as at least 10 percent by weight, at least 15 percent by weight, or at least 20 percent by weight and/or up to 40 percent by weight, such as up to 30 percent by weight or up to 25 percent by weight, based on the total weight of the composition, the weight percents being based on the total weight of the composition.

In embodiments, the present invention is directed to a composition of any of the previous thirteen paragraphs, wherein the composition further comprises a filler, such as calcium carbonate, wherein, in some embodiments, the filler is present in the composition in an amount of at least 10 percent by weight, such as at least 20 percent by weight, at least 25 percent by weight, or in some cases, at least 30 percent by weight and/or up to 70 percent by weight, such as up to 60 percent by weight, or, in some cases, up to 50 percent by weight, the weight percents being based on the total weight of the composition.

In embodiments, the present invention is directed to a method of using a composition of any of the previous fourteen paragraphs, comprising depositing the composition over at least a portion of an aperture to seal the aperture.

As will further be appreciated by the foregoing description, embodiments of the present invention are directed to compositions comprising: (a) 20 to 80 percent by weight, based on the total weight of the composition, of an aqueous polyurethane dispersion prepared from an isocyanate-terminated prepolymer having an isocyanate content of 2 to 7 weight percent, such as 2 to 4 weight percent, and comprising a reaction product of components comprising: (i) a polyol component comprising: (A) polyether diol having a molecular weight of 3000 to 6000; and (B) a diol or triol having a molecular weight of up to 700, such as 200 to 700; (ii) a hydroxyalkane carboxylic acid having a molecular weight of less than 200; and (iii) an aliphatic and/or cycloaliphatic diisocyanate; (b) 5 to 25 percent by weight, based on the total weight of the composition, of a hydroxyl-functional compound having an average hydroxyl equivalent weight of greater than 40 gram/equivalent to less than 500 gram/equivalent; and (c) 30 to 50 percent by weight of a filler, based on the total weight of the coating composition.

In embodiments, the present invention is directed to a composition of the previous paragraph, wherein the polyether dial comprises a polyoxypropylene diol.

In embodiments, the present invention is directed to a composition of any of the previous two paragraphs, wherein the diol or trial having a molecular weight of up to 700, such as 200 to 700, comprises a polyester diol, a polyether diol, such as a polyoxypropylene diol, and/or a fatty acid ester having a hydroxyl group, such as castor oil.

In embodiments, the present invention is directed to a composition of any of the previous three paragraphs, wherein the polyol component comprises (C) a triol, such as a polyether triol, having a molecular weight of 3,000 to 9,000, such as 5,000 to 7,000.

In embodiments, the present invention is directed to a composition of any of the previous four paragraphs, wherein the components further comprise a monol, such as a polyether monol having a molecular weight of 400 to 3000, such as 1500 to 2500.

In embodiments, the present invention is directed to a composition of any of the previous five paragraphs, wherein the isocyanate-terminated prepolymer is prepared by reacting the components in amounts such that the ratio of isocyanate groups to hydroxyl groups is in the range of 3:1 to 1.4:1, such as 1.7:1 to 1.4:1.

In embodiments, the present invention is directed to a composition of any of the previous six paragraphs, wherein the components used to prepare the isocyanate-functional prepolymer are used in the following amounts: (1) 30 to 80 weight percent, such as 50 to 70 weight percent, polyether diol having a molecular weight of 3000 to 6000; (2) 3 to 15 weight percent, such as 5 to 10 weight percent, diol or triol having a molecular weight of up to 700, such as 200 to 700; (3) 1 to 20 weight percent, such as 1.5 to 10 weight percent carboxylic acid comprising a hydroxyl and/or an amine group; (4) 0 to 40 weight percent, such as 2 to 5 weight percent, polyether monol having a molecular weight between 400-3,000; and (5) 0 to 15 weight percent, such as 2 to 10 weight percent, polyether triol having a molecular weight of 3,000 to 9,000, all weight percentages being based on the total weight of the prepolymer.

In embodiments, the present invention is directed to a composition of any of the previous seven paragraphs, wherein the aqueous polyurethane dispersion is optionally chain extended and optionally has at least a portion of any carboxylic acid groups neutralized.

In embodiments, the present invention is directed to a composition of any of the previous eight paragraphs, wherein the aqueous polyurethane dispersion is present in an amount of up to 60 percent by weight or up to 40 percent by weight, based on the total weight of the composition.

In embodiments, the present invention is directed to a composition of any of the previous nine paragraphs, wherein the hydroxyl-functional compound has an average hydroxyl equivalent weight of greater than 60 gram/equivalent or greater than 80 gram/equivalent and less than 400 gram/equivalent or less than 300 gram/equivalent or less than 250 gram/equivalent.

In embodiments, the present invention is directed to a composition of the previous paragraph, wherein the hydroxyl-functional compound has an average hydroxyl equivalent weight of 96 gram/equivalent to 212 gram/equivalent.

In embodiments, the present invention is directed to a composition of any of the previous eleven paragraphs, wherein the hydroxyl-functional compound comprises a monomeric polyol, such as an alkylene glycol, such as 1,3-butanediol, 2-methyl-1,3-propanediol, diethylene glycol, triethylene glycol, dipropylene glycol, and/or tripropylene glycol, and/or a polymeric polyol, such as a polyether polyol, such as a polypropylene glycol.

In embodiments, the present invention is directed to a composition of any of the previous twelve paragraphs, wherein the hydroxyl-functional compound is present in the composition in an amount of at least at least 10 percent by weight, at least 15 percent by weight, or at least 20 percent by weight and up to 25 percent by weight, based on the total weight of the composition.

In embodiments, the present invention is directed to a composition of any of the previous thirteen paragraphs, wherein the filler comprises calcium carbonate.

In embodiments, the present invention is directed to a method of using a composition of any of the previous fourteen paragraphs, comprising depositing the composition over at least a portion of an aperture to seal the aperture.

Illustrating the invention are the following examples that do not limit the invention to their details. All parts and percentages in the examples, as well as throughout the specification, are by weight unless otherwise indicated.

### EXAMPLES

### Examples 1-11

Sealant formulations were prepared using the ingredients and amounts (in parts by weight) listed in Table 1. All components were added into a Flack Tech cup, with the exception of the Dispercoll® U XP 2699 dispersion, and then placed in the spin mixer for forty-five seconds. The Dispercoll® U XP 2699 dispersion was then post-added and hand mixed for approximately one minute. Next, the sealant composition was drawn down at 100 mils and allowed to cure at room temperature for 48 hours.

Once cured, the films were submitted for physical testing. Results of physical testing for the cured films are set forth in Table 1. Tensile, Elongation, and modulus at 100% extension were determined by ASTM D412, Method A. Tear resistances were determined by ASTM D624, Die “C”. Shore A hardness was determined by ASTM D 2240.

TABLE 1

| | Example 1 | Example 2 | Example 3 | Example 4 | Example 5 | Example 6 | Example 7 |
|---|---|---|---|---|---|---|---|
| Ingredient | (comparative) | (comparative) | (comparative) | (inventive) | (inventive) | (inventive) | (inventive) |
| Dispercoll ® U XP 2699¹ | 30.05 | 31.5 | 32.53 | 28.55 | 31.81 | 38.58 | 41.63 |
| Arcol ® PPG-2000² | 28.55 | 25.16 | 22.73 | — | — | — | — |
| Arcol ® PPG-425¹¹ | — | — | — | 28.05 | 22.26 | 18.28 | 15.23 |
| Acclaim ® 4200¹² | — | — | — | — | — | — | — |
| Monol¹³ | — | — | — | — | — | — | — |
| Mesamoll ®¹⁴ | — | — | — | — | — | — | — |
| Ti-Pure ® R-900³ | 1.0 | 1.05 | 1.08 | 1.05 | 1.11 | 1.07 | 1.07 |
| TAMOL ™ 850⁴ | 0.18 | 0.19 | 0.19 | 0.19 | 0.20 | 0.19 | 0.19 |
| TRITON ™ X-405⁵ | 0.54 | 0.57 | 0.58 | 0.57 | 0.60 | 0.58 | 0.58 |
| Ethylene Glycol | 1.50 | 1.57 | 1.62 | 1.57 | 1.66 | 1.59 | 1.59 |
| Tinuvin ® 292⁶ | 0.10 | 0.10 | 0.11 | 0.10 | 0.11 | 0.10 | 0.10 |
| Tinuvin ® 1130⁷ | 0.10 | 0.10 | 0.11 | 0.10 | 0.11 | 0.10 | 0.10 |
| Irganox ® 1135⁸ | 0.10 | 0.10 | 0.11 | 0.10 | 0.11 | 0.10 | 0.10 |
| Atomite ®⁹ | 9.47 | 9.86 | 10.19 | 9.88 | 10.45 | 10.03 | 10.03 |
| Drikalite ®¹⁰ | 28.41 | 29.78 | 30.75 | 29.83 | 31.57 | 29.37 | 29.37 |
| Physical Testing Results | | | | | | | |
| Tensile (PSI) | 116 | 222 | 197 | 102 | 121 | 117 | 197 |
| Modulus at 100% | 98 | 170 | 136 | 45 | 62 | 43 | 88 |
| extension (PSI) | | | | | | | |
| Elongation (%) | 159 | 215 | 412 | 573 | 614 | 1020 | 882 |
| Tear (PLI) | 30 | 39 | 69 | 34 | 40 | 43 | 57 |
| Shore A Hardness | 27 (24) | 38 (36) | 38 (36) | 16 (15) | 19 (17) | 20 (16) | 33 (30) |
| 1 Sec (5 sec) | | | | | | | |

| | Example 8 | Example 9 | Example 10 | Example 11 |
|---|---|---|---|---|
| Ingredient | (inventive) | (comparative) | (comparative) | (comparative) |
| Dispercoll ® U XP 2699¹ | 32.29 | 30.05 | 31.5 | 32.53 |
| Arcol ® PPG-2000² | — | — | — | — |
| Arcol ® PPG-425¹¹ | 24.22 | — | — | — |
| Acclaim ® 4200¹² | — | 28.55 | — | — |
| Monol¹³ | — | — | 25.16 | 22.73 |
| Ti-Pure ® R-900³ | 1.08 | 1.0 | 1.05 | 1.08 |
| TAMOL ™ 850⁴ | 0.19 | 0.18 | 0.19 | 0.19 |
| TRITON ™ X-405⁵ | 0.59 | 0.54 | 0.57 | 0.58 |
| Ethylene Glycol | 1.58 | 1.50 | 1.57 | 1.62 |
| Tinuvin ® 292⁶ | 0.10 | 0.10 | 0.10 | 0.10 |
| Tinuvin ® 1130⁷ | 0.10 | 0.10 | 0.10 | 0.11 |
| Irganox ® 1135⁸ | 0.10 | 0.10 | 0.10 | 0.11 |
| Atomite ®⁹ | 10.12 | 9.47 | 9.86 | 10.19 |
| Drikalite ®¹⁰ | 29.63 | 28.41 | 29.78 | 30.75 |
| Physical Testing Results | | | | |
| Tensile (PSI) | 140 | 81 | 166 | 103 |
| Modulus at 100% extension | 66 | | 162 | 86 |
| (PSI) | | | | |
| Elongation (%) | 610 | 32 | 101 | 102 |
| Tear (PLI) | 44 | 18 | 51 | 30 |
| Shore A Hardness | 21 (19) | 36 (35) | 44 (40) | 35 (31) |
| 1 Sec (5 sec) | | | | |

¹aliphatic, high-molecular-weight, waterborne polyurethane dispersion available from Bayer MaterialScience, LLC
²2,000-molecular weight polypropylene glycol commercially available from Bayer MaterialScience, LLC
³titanium dioxide pigment commercially available from DuPont.
⁴dispersant from The Dow Chemical Company
⁵surfactant from The Dow Chemical Company
⁶liquid hindered-amine light stabilizer (HALS) from BASF
⁷liquid UV absorber from BASF
⁸antioxidant from BASF
⁹ calcium carbonate from IMERYS
¹⁰calcium carbonate from IMERYS
¹¹425-molecular weight polypropylene glycol commercially available from Bayer MaterialScience, LLC
¹²4000-molecular weight polypropylene glycol commercially available from Bayer MaterialScience, LLC
¹³a monofunctional polyetheralcohol having an equivalent weight of 4000 as described in United States Patent Application Publication No. 2011/0263797 A1 at [0125] and [0137]

### Examples 12-24

Sealant formulations were prepared using the ingredients and amounts (in parts by weight) listed in Table 2. All components were added into a Flack Tech cup, with the exception of the Dispercoll® U XP 2699 dispersion, and then placed in the spin mixer for ten seconds. The Dispercoll® U XP 2699 dispersion was then post-added and hand mixed for approximately one minute before being placed on the spin mixer for an additional 10 seconds. Next, the sealant composition was drawn down at 100 mils and allowed to cure at room temperature for 7 days.

Once cured, the films were submitted for physical testing. Results of physical testing for the cured films are set forth in Table 2. Tensile, Elongation, and Modulus at 100% extension were determined by ASTM D412, Method A. Tear resistances were determined by ASTM D624, Die “C”. Shore A hardness was determined by ASTM D 2240.

TABLE 2

| | Example 12 | Example 13 | Example 14 | Example 15 | Example 16 | Example 17 | Example 18 |
|---|---|---|---|---|---|---|---|
| Ingredient | (comparative) | (comparative) | (comparative) | (comparative) | (comparative) | (inventive) | (inventive) |
| Dispercoll ® U XP 2699¹ | 28.55 | 31.82 | 32.28 | 38.58 | 41.63 | 28.55 | 31.81 |
| Arcol ® PPG-1000¹⁴ | 28.05 | 22.27 | 24.21 | 18.21 | 15.23 | — | — |
| Tripropylene Glycol | — | — | — | — | — | 28.05 | 22.26 |
| Mesamoll ®¹⁵ | — | — | — | — | — | — | — |
| Ti-Pure ® R-900³ | 1.05 | 1.11 | 1.08 | 1.07 | 1.07 | 1.05 | 1.11 |
| TAMOL ™ 850⁴ | 0.19 | 0.19 | 0.20 | 0.19 | 0.19 | 0.19 | 0.20 |
| TRITON ™ X-405⁵ | 0.57 | 0.60 | 0.59 | 0.58 | 0.58 | 0.57 | 0.60 |
| Ethylene Glycol | 1.57 | 1.66 | 1.58 | 1.59 | 1.59 | 1.57 | 1.66 |
| Tinuvin ® 292⁶ | 0.10 | 0.10 | 0.11 | 0.10 | 0.10 | 0.1 | 0.11 |
| Tinuvin ® 1130⁷ | 0.10 | 0.10 | 0.11 | 0.10 | 0.10 | 0.1 | 0.11 |
| Irganox ® 1135⁸ | 0.10 | 0.11 | 0.10 | 0.10 | 0.10 | 0.1 | 0.11 |
| Atomite ®⁹ | 9.88 | 10.45 | 10.12 | 10.03 | 10.03 | 9.88 | 10.45 |
| Drikalite ®¹⁰ | 29.83 | 31.58 | 29.62 | 29.37 | 29.37 | 29.83 | 31.57 |
| Physical Testing Results | | | | | | | |
| Tensile (PSI) | 164 | 229 | 234 | 366 | 391 | 12 | 23 |
| Modulus at 100% | 70 | 152 | 130 | 202 | 296 | 8 | 13 |
| extension (PSI) | | | | | | | |
| Elongation (%) | 765 | 348 | 522 | 653 | 415 | 392 | 601 |
| Tear (PLI) | 32 | 80 | 72 | 100 | 133 | 3 | 12 |
| Shore A Hardness | 21 (18) | 44 (42) | 38 (36) | 48 (46) | 58 (56) | 0 (0) | 2 (1) |
| 1 Sec (5 sec) | | | | | | | |

| | Example 19 | Example 20 | Example 21 | Example 22 | Example 23 | Example 24 |
|---|---|---|---|---|---|---|
| Ingredient | (inventive) | (inventive) | (inventive) | (inventive) | (comparative) | (comparative) |
| Dispercoll ® U XP 2699¹ | 32.29 | 38.58 | 41.63 | 43.93 | 30.05 | 33.79 |
| Arcol ® PPG-1000¹⁴ | — | — | — | — | — | — |
| Tripropylene Glycol | 24.22 | 18.28 | 15.23 | 10.55 | — | — |
| Mesamoll ®¹⁵ | — | — | — | — | 28.55 | 24 |
| Ti-Pure ® R-900³ | 1.08 | 1.07 | 1.07 | 1.13 | 1 | 0 |
| TAMOL ™ 850⁴ | 0.19 | 0.19 | 0.19 | 0.20 | 0.18 | 0.49 |
| TRITON ™ X-405⁵ | 0.59 | 0.58 | 0.58 | 0.61 | 0.54 | 0.49 |
| Ethylene Glycol | 1.58 | 1.59 | 1.59 | 1.68 | 1.50 | 1.96 |
| Tinuvin ® 292⁶ | 0.1 | 0.1 | 0.1 | 0.11 | 0.10 | 0 |
| Tinuvin ® 1130⁷ | 0.1 | 0.1 | 0.1 | 0.11 | 0.10 | 0 |
| Irganox ® 1135⁸ | 0.1 | 0.1 | 0.1 | 0.11 | 0.10 | 0 |
| Atomite ®⁹ | 10.12 | 10.03 | 10.03 | 10.58 | 9.47 | 0 |
| Drikalite ®¹⁰ | 29.63 | 29.37 | 29.37 | 30.99 | 28.41 | 39.26 |
| Physical Testing Results | | | | | | |
| Tensile (PSI) | 23 | 49 | 73 | 50 | 97 | 115 |
| Modulus at 100% | 11 | 20 | 30 | 31 | 52 | |
| extension (PSI) | | | | | | |
| Elongation %) | 685 | 1112 | 1182 | 1211 | 682 | 70 |
| Tear (PLI) | 9 | 14 | 23 | 17 | 36 | 20 |
| Shore A Hardness | 4 (3) | 6 (5) | 19 (16) | 16 (12) | 20 (17) | 47 (44) |
| 1 Sec (5 sec) | | | | | | |

¹⁴1,000-molecular weight polypropylene glycol commercially available from Bayer MaterialScience, LLC
¹⁵alkylsulphonic acid ester with phenol from LANXESS Deutschland GmbH

### Examples 25-29

### Comparative

Sealant formulations were prepared using the ingredients and amounts (in parts by weight) listed in Table 3. All components were added into a Flack Tech cup, with the exception of the Dispercoll® U XP 2699 dispersion, and then placed in the spin mixer for one minute at 2400 rpm. The Dispercoll® U XP 2699 dispersion was then post-added and mixed on the spin mixer for an additional 20 seconds at 2400 rpm. Next, the sealant composition was drawn down at 100 mils and allowed to cure.

Once cured, the films were submitted for physical testing. Results of physical testing for the cured films are set forth in Table 3. Tensile, Elongation, and Modulus at 100% extension were determined by ASTM D412, Method A. Tear resistances were determined by ASTM D624, Die “C”. Shore A hardness was determined by ASTM D 2240.

TABLE 3

| | Example 25 | Example 26 | Example 27 | Example 28 | Example 29 |
|---|---|---|---|---|---|
| Ingredient | (comparative) | (comparative) | (comparative) | (comparative) | (comparative) |
| Dispercoll ® U XP 2699¹ | 39.68 | 39.29 | 37.79 | 36.07 | 36.93 |
| Drikalite ®¹⁰ | 39.68 | 39.29 | 37.79 | 36.07 | 36.93 |
| Unimol ® BB¹⁶ | 19.78 | 19.58 | 18.84 | 17.98 | 18.41 |
| TAMOL ™ 850⁴ | 0.2 | 0.2 | 0.19 | 0.18 | 0.19 |
| TRITON ™ X-405⁵ | 0.60 | 0.59 | 0.57 | 0.55 | 0.56 |
| ACRYSOL ™ RM-8W¹⁷ | 0.06 | 0.06 | 0.05 | 0.05 | 0.05 |
| Ethylene Glycol | 0 | 0.99 | 4.76 | 9.09 | 6.93 |

Physical Testing Results

| | | | | | |
|---|---|---|---|---|---|
| Tensile (PSI) | 299 | 243 | 45 | 179 | 289 |
| Modulus at 100% | 287 | 196 | 31 | 163 | 240 |
| extension (PSI) | | | | | |
| Elongation (%) | 210 | 420 | 1000 | 263 | 365 |
| Tear (PLI) | 74 | 68 | 16 | 16 | 85 |
| Shore A Hardness | 57 (51) | 50 (42) | 21 (11) | 27 (14) | 41 (37) |
| 1 Sec (5 sec) | | | | | |

¹⁶benzyl butyl phthalate available from LANXESS
¹⁷rheology modifier from The Dow Chemical Company

### Example 30

### Comparative

A sealant formulation was prepared using the ingredients and amounts (in parts by weight) listed in Table 4. All components were added into a Flack Tech cup, with the exception of the Dispercoll® U XP 2699 dispersion, and then placed in the spin mixer for one minute at 2400 rpm. The Dispercoll® U XP 2699 dispersion was then post-added and mixed on the spin mixer for an additional 15 seconds at 2400 rpm. Next, the sealant composition was drawn down at 100 mils and allowed to cure.

Once cured, the film was submitted for physical testing. Results of physical testing for the cured film are set forth in Table 4. Tensile, Elongation, and Modulus at 100% extension were determined by ASTM D412, Method A. Tear resistances were determined by ASTM D624, Die “C”. Shore A hardness was determined by ASTM D 2240.

TABLE 4

| | Example 30 |
|---|---|
| Ingredient | (comparative) |
| Dispercoll ® U XP 2699¹ | 36.93 |
| Drikalite ®¹⁰ | 36.93 |
| Unimol ® BB¹⁶ | 18.41 |
| TAMOL ™ 850⁴ | 0.19 |
| TRITON ™ X-405⁵ | 0.56 |
| ACRYSOL ™ RM-8W¹⁷ | 0.05 |
| 1,3-Propanediol | 6.93 |

Physical Testing Results

| | |
|---|---|
| Tensile (PSI) | 17 |
| Modulus at 100% extension (PSI) | 8 |
| Elongation (%) | 1000 |
| Tear (PLI) | 6 |
| Shore A Hardness | 3 (1) |
| 1 Sec (5 sec) | |

High performance sealants typically have low modulus at 100% extension, high elongation properties, moderate tensile strength, and higher tear resistance. To achieve low modulus with sealants based on polyurethane dispersions, non-functional plasticizers have typically been added in relatively high amounts to lower the modulus of the formulated sealant. Sealants with high levels of plasticizers may undergo a loss of plasticizer over time or on heat aging, however, which can lead to changing physical properties, loss of adhesion, or paintability issues. Sealants compositions comprising a hydroxyl-functional compound having an average hydroxyl equivalent weight of greater than 40 gram/equivalent to less than 500 gram/equivalent, which is currently believed to act as a plasticizer, can allow for the formulation of lower modulus sealants at a lower percentage of plasticizer, as illustrated by examples 4-8 and 17-22. Sealants with a lower percentage of plasticizer are preferable over sealants with large amounts of non-functional plasticizers (comparative examples 23-30) or sealants containing hydroxyl functional plasticizers with too high or low of an equivalent weight to be effective (comparative examples 1-3 and 9-16).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A composition comprising:
(a) an aqueous polyurethane dispersion prepared from an isocyanate-terminated prepolymer comprising a reaction product of components comprising:
(i) a polyol component;
(ii) a carboxylic acid comprising a hydroxyl and/or an amine group; and
(iii) a polyisocyanate; and
(b) a hydroxyl-functional compound having an average hydroxyl equivalent weight of greater than 40 gram/equivalent to less than 500 gram/equivalent.

2. The composition of claim 1, wherein the isocyanate-terminated prepolymer has an isocyanate group content of 2 to 7 weight percent.

3. The composition of claim 1, wherein the polyol component comprises (A) a polyether diol.

4. The composition of claim 3, wherein the polyether diol has a molecular weight of 3000 to 6000.

5. The composition of claim 4, wherein the polyol component further comprises (B) a diol or triol having a molecular weight of 200 to 700.

6. The composition of claim 5, wherein the carboxylic acid comprising a hydroxyl and/or an amine group comprises a hydroxyalkane carboxylic acid having a molecular weight of less than 200.

7. The composition of claim 1, wherein the isocyanate-terminated prepolymer comprises a reaction product of components comprising:
(1) 30 to 80 weight percent of a polyether diol having a molecular weight of 3000 to 6000;
(2) 3 to 15 weight percent of a diol or triol having a molecular weight of 200 to 700; and
(3) 1 to 20 weight percent of a carboxylic acid comprising a hydroxyl and/or an amine group; and
the weight percentages being based on the total weight of the prepolymer.

8. The composition of claim 1, the aqueous polyurethane dispersion optionally being chain extended and having at least a portion of any carboxylic acid groups neutralized.

9. The composition of claim 1, wherein the aqueous polyurethane dispersion is present in an amount of at least 15 percent by weight and up to 80 percent by weight, based on the total weight of the composition.

10. The composition of claim 1, wherein the hydroxyl-functional compound has an average hydroxyl equivalent weight of greater than 80 gram/equivalent and less than 250 gram/equivalent.

11. The composition of claim 1, wherein the hydroxyl-functional compound comprises a polyether glycol.

12. The composition of claim 1, wherein the hydroxyl-functional compound is present in the composition in an amount of at least 10 percent by weight and up to 30 percent by weight, the weight percents being based on the total weight of the composition.

13. The composition of claim 1, further comprising calcium carbonate in an amount of at least 30 percent by weight and up to 50 percent by weight, based on the total weight of the composition.

14. A composition comprising:
(a) an aqueous polyurethane dispersion prepared from an isocyanate-terminated prepolymer having an isocyanate content of 2 to 7 weight percent and comprising a reaction product of components comprising:
(i) a polyol component comprising:
(A) polyether diol having a molecular weight of 3000 to 6000; and
(B) a diol or triol having a molecular weight of 200 to 700;
(ii) a hydroxyalkane carboxylic acid having a molecular weight of less than 200; and
(iii) an aliphatic and/or cycloaliphatic diisocyanate; and
(b) a hydroxyl-functional compound having an average hydroxyl equivalent weight of greater than 40 gram/equivalent to less than 500 gram/equivalent.

15. The composition of claim 14, wherein the aqueous polyurethane dispersion is present in an amount of at least 15 percent by weight and up to 80 percent by weight, based on the total weight of the composition.

16. The composition of claim 14, wherein the hydroxyl-functional compound has an average hydroxyl equivalent weight of greater than 80 gram/equivalent and less than less than 250 gram/equivalent.

17. The composition of claim 16, wherein the hydroxyl-functional compound comprises a polyether glycol.

18. The composition of claim 14, wherein the hydroxyl-functional compound is present in the composition in an amount of at least 10 percent by weight and up to 30 percent by weight, the weight percents being based on the total weight of the composition.

19. The composition of claim 14, further comprising calcium carbonate in an amount of at least 30 percent by weight and up to 50 percent by weight, based on the total weight of the composition.

20. A composition comprising:
(a) 20 to 80 percent by weight, based on the total weight of the composition, of an aqueous polyurethane dispersion prepared from an isocyanate-terminated prepolymer having an isocyanate content of 2 to 7 weight percent and comprising a reaction product of components comprising:
(i) a polyol component comprising:
(A) polyether diol having a molecular weight of 3000 to 6000; and
(B) a diol or triol having a molecular weight of up to 700;
(ii) a hydroxyalkane carboxylic acid having a molecular weight of less than 200; and
(iii) an aliphatic and/or cycloaliphatic diisocyanate;
(b) 5 to 25 percent by weight, based on the total weight of the composition, of a hydroxyl-functional compound having an average hydroxyl equivalent weight of greater than 40 gram/equivalent to less than 500 gram/equivalent; and
(c) 30 to 50 percent by weight of a filler, based on the total weight of the composition.
